(19) United States
(12) Patent Application Publication
(10) Pub. No.: US 2023/0055368 A1
(43) Pub. Date: Feb. 23, 2023

(54) SMALL-AREA WIPING

(71) Applicant: VALEO SYSTEMES D'ESSUYAGE, LormandLa Verriere (FR)

(72) Inventors: Vincent IZABEL, La Verriere (FR); Jean-Michel JARASSON, La Verriere (FR); Gerald CAILLOT, La Verriere (FR); Frederic GIRAUD, La Verriere (FR); Marcel TREBOUET, La Verriere (FR); Alexandre PASCHUTINE, La Verriere (FR); Mehdi BELHAJ, La Verriere (FR)

(73) Assignee: VALEO SYSTEMES D'ESSUYAGE, La Verriere (FR)

(21) Appl. No.: 17/795,694

(22) PCT Filed: Jan. 11, 2021
(86) PCT No.: PCT/EP2021/050412

§ 371 Date: Jul. 27, 2022

(30) Foreign Application Priority Data
Jan. 28, 2020 (FR) FR2000820

(51) Int. Cl. B60S 1/56; B60S 1/38; B60S 1/40; B60S 1/34

(52) U.S. Cl. CPC B60S 1/566; B60S 1/3872; B60S 1/40; B60S 1/3427

(57) ABSTRACT

Wiper blade for a wiping system, in particular for wiping a camera of a motor vehicle, the wiper blade comprising a connection device suitable for releasable connection to a drive shaft of the wiper blade, said connection device comprising a first orientation which allows mounting/dismounting relative to a drive shaft, and a second orientation which does not allow such mounting/dismounting.

### CROSS-REFERENCE TO RELATED APPLICATIONS

This application is filed under 35 U.S.C. § 371 U.S. National Phase of International Application No. PCT/EP2021/050412 filed Jan. 11, 2021 (published as WO2021151646), which claims priority benefit to French application No. 2000820 filed on Jan. 28, 2020, the disclosures of which are herein incorporated by reference in their entirety.

### TECHNICAL FIELD

The present invention relates to the field of wiping, and more particularly to the field of wiping systems intended for motor vehicles. The invention relates to a wiping system comprising a shaft and a blade, and to a shaft and a blade per se of such a wiping system.

### BACKGROUND OF THE INVENTION

Motor vehicles are commonly equipped with a wiping system comprising at least one blade for wiping a glazed surface, such as a windscreen. A wiper blade is driven, via an arm, by a drive motor between two end positions. The wiper blade is connected to the arm by means of a ball-and-socket joint, which requires a complex connector design. These wiping solutions are well suited to large glass surfaces, but less so to small surfaces due to their size, cost and complexity. There are other wiping needs, however, particularly for small surfaces. For example, in the context of an autonomous vehicle, it is important to guarantee the surface condition of several cameras, and possibly lighting systems, as the safety of these autonomous vehicles depends heavily on these devices.

### BRIEF SUMMARY OF THE INVENTION

A general object of the invention is to provide a reliable and simple wiping solution, especially suitable for wiping a small surface such as a camera for an autonomous vehicle.

For this purpose, a wiper blade for a wiping system is proposed, in particular for wiping a camera of a motor vehicle.

According to one aspect of the invention, the blade comprises a connection device suitable for releasable connection to a drive shaft of the wiper blade, said connection device comprising a first orientation which allows mounting and dismounting relative to a drive shaft, and a second orientation which does not allow such mounting and dismounting.

The use of such a blade allows quick and easy mounting and dismounting of the wiper blade, without tools, while ensuring a solid and reliable attachment of the wiper blade to the drive shaft.

According to one embodiment, the connection device further comprises an opening at one end of the wiper blade, comprising at least two enlarged portions for mounting and dismounting of the latter.

According to another embodiment, the blade further comprises an anti-rotation means, in particular by at least one protrusion at an opening of its connection device or by a collar comprising at least one housing for cooperating with at least one stop of a drive shaft.

According to another embodiment, the blade further comprises a mount forming guides for the releasable translational attachment of a wiping element intended to come into contact with the surface to be wiped.

Also proposed is a wiping system which, according to another aspect of the invention, comprises a drive shaft and a wiper blade as described above, said blade being releasably attached to this drive shaft.

According to an embodiment, the system further comprises an operating configuration in which a resilient means exerts a force on the wiper blade tending to hold it in abutment against at least one stop of the drive shaft, in particular a pin, to lock the wiper blade in this operating configuration.

According to an embodiment, the wiper blade and the drive shaft comprise respective connection devices configured to allow their assembly and/or disassembly by their successive actuation according to a first relative movement in translation parallel to the axis of the drive shaft.

According to an embodiment, the wiper blade and the drive shaft comprise respective anti-rotation means configured to form an anti-rotation device for the wiper blade relative to the drive shaft in said operating configuration.

Advantageously, the drive shaft comprises a first portion with grooves forming an anti-rotation means, and the wiper blade comprises an opening with protrusions of a size corresponding to the grooves, configured to fit into the grooves in said operating configuration of the wiping system and to form an anti-rotation device.

Advantageously, the drive shaft comprises a pin forming an anti-rotation means and a locking stop, the wiper blade comprising an anti-rotation collar comprising recesses configured to co-operate with the pin in said operating configuration of the wiping system, thereby forming an anti-rotation means and a means for locking the wiper blade to the drive shaft.

According to another embodiment, the resilient means comprises a resilient washer, in particular arranged between two flat washers.

Also proposed is a drive shaft for a wiping system, as described above.

Also proposed is a camera or lighting device for an autonomous vehicle, which according to another aspect of the invention comprises at least one wiping system as described above.

Also proposed is a vehicle, preferably an autonomous vehicle, which according to another aspect of the invention comprises a wiping system, a camera, or a lighting device as described above.

### BRIEF DESCRIPTION OF THE DRAWINGS

These objects, features and advantages of the present invention will be described in detail in the following description of particular non-limiting embodiments with reference to the appended figures, in which:

FIG. 1 shows a wiping system according to a first embodiment of the invention.

FIG. 2 shows a mount of a wiper blade of the wiping system according to the first embodiment of the invention.

FIG. 3 shows a wiper blade of the wiping system according to the first embodiment of the invention.

FIG. 4 shows a side view of a drive shaft of the wiping system according to the first embodiment of the invention.

FIG. 5 shows a perspective view of the drive shaft of the wiping system according to the first embodiment of the invention.

FIG. 6 shows a plan view of the drive shaft of the wiping system according to the first embodiment of the invention.

FIG. 7 shows an exploded view of a resilient means of the wiping system according to the first embodiment of the invention.

FIG. 8 shows a view of the resilient means mounted on the drive shaft of the wiping system according to the first embodiment of the invention.

FIG. 9 shows a further view of the resilient means mounted on the drive shaft of the wiping system according to the first embodiment of the invention.

FIG. 10 shows a view of the mount of the wiper blade mounted on the drive shaft of the wiping system according to the first embodiment of the invention.

FIG. 11 shows a further view of the mount of the wiper blade mounted on the drive shaft of the wiping system according to the first embodiment of the invention.

FIG. 12 shows a side view of a mount of a wiper blade according to a variant of the first embodiment of the invention.

FIG. 13 shows a further view of the mount of a wiper blade according to the variant of the first embodiment of the invention.

FIG. 14 shows a wiper blade of the wiping system according to the variant of the first embodiment of the invention.

FIG. 15 shows a wiping system according to a second embodiment of the invention.

FIG. 16 shows an anti-rotation collar of the wiping system according to the second embodiment of the invention.

FIG. 17 shows part of the wiper blade of the wiping system according to the second embodiment of the invention.

FIG. 18 shows a perspective view, from above, of a wiper blade of the wiping system according to the second embodiment of the invention.

FIG. 19 shows a perspective view, from beneath, of a wiper blade of the wiping system according to the second embodiment of the invention.

FIG. 20 shows a view of a drive shaft of the wiping system according to the second embodiment of the invention.

FIG. 21 shows a view of a drive shaft of the wiping system comprising a resilient means and an anti-rotation collar according to the second embodiment of the invention.

FIG. 22 shows a further view of a drive shaft of the wiping system comprising a resilient means and an anti-rotation collar according to the second embodiment of the invention.

FIG. 23 shows a view of a wiping system according to a third embodiment of the

invention.

FIG. 24 shows a view of a lower shaft portion of the shaft of the wiping system according to the third embodiment of the invention.

FIG. 25 shows a view of an upper shaft portion of the shaft of the wiping system according to the third embodiment of the invention.

FIG. 26 shows a view of the shaft of the wiping system according to the third embodiment of the invention.

FIG. 27 shows a view of a wiping system according to a variant of the third embodiment of the invention.

FIG. 28 shows a view of an end piece of a mount of the wiper blade according to the variant of the third embodiment of the invention.

FIG. 29 shows a view of a mount of the wiper blade according to the variant of the third embodiment of the invention.

FIG. 30 shows a view of the blades of a mount of the wiper blade according to the variant of the third embodiment of the invention.

FIG. 31 shows a further view of the mount of the wiper blade according to the variant of the third embodiment of the invention.

FIG. 32 shows a view of the wiper blade according to the variant of the third embodiment of the invention.

FIG. 33 shows a view of the wiper blade to which a supply hose is connected according to the variant of the third embodiment of the invention.

FIG. 34 shows a further view of a wiping system according to the variant of the third embodiment of the invention.

FIG. 35 shows a further view of a wiping system according to the variant of the third embodiment of the invention.

### DETAILED DESCRIPTION OF THE INVENTION

To simplify the description, the same references will be used to denote identical or similar elements in the various embodiments of the invention.

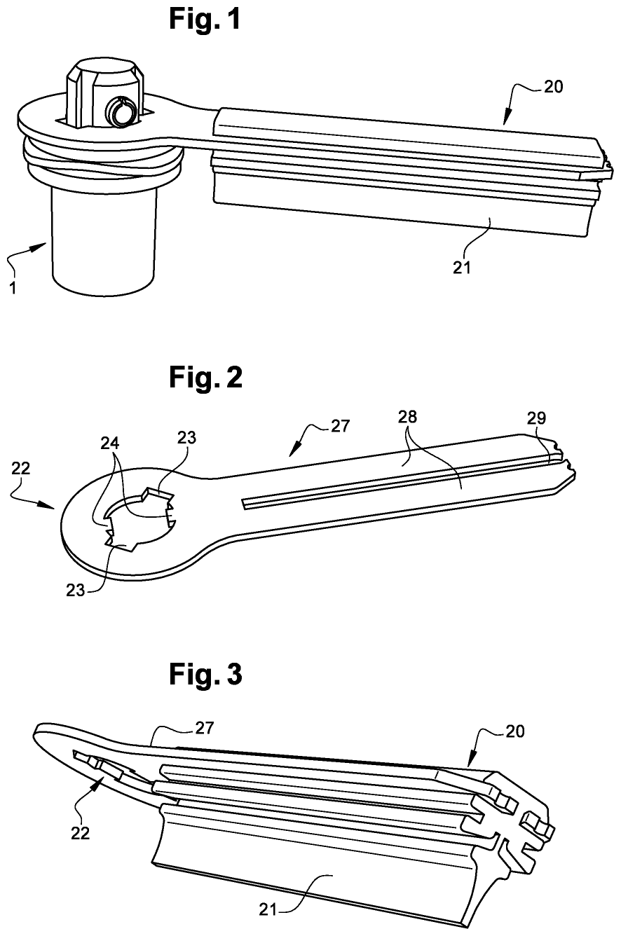

FIGS. 1 and 11 illustrate a wiping system according to a first embodiment of the invention. This wiping system comprises, on the one hand, a drive shaft 1, which will also be referred to more simply as shaft 1, or arm, intended to be driven in rotation on itself about its longitudinal axis by a motor, not shown, and, on the other hand, a wiper blade 20 comprising a wiping element 21 intended to remain in contact with a surface to be wiped, not shown. The wiper blade 20 is driven in rotation by the shaft 1, allowing its wiping element 21 to wipe the surface. To facilitate maintenance of the wiping system, the wiper blade 20 is releasably mounted on the shaft 1 in a user-friendly, simple and reliable manner, as will be detailed below.

FIG. 2 shows the mount 27 of the wiper blade 20, the mount comprising a first end forming a connection device 22, suitable for cooperating with the shaft 1, from which two flat, straight and parallel blades 28, separated by a slot 29, extend to a second end of the wiper blade 20 opposite the connection device 22. This connection device 22 has a generally circular external shape in disc form and comprises a central opening which more particularly fulfils the connection function. This opening has a generally circular shape, enlarged by a rectangular part forming two enlarged portions 23 with respect to the circular opening, i.e. increasing the size of the opening. Between these two enlarged portions 23, the opening comprises a generally circular part, interrupted by two segments or protrusions 24 narrowing the opening, extending towards the centre of the connection device 22. The mount 27 forms a rigid frame, preferably made of metal, of the wiper blade 20.

FIG. 3 illustrates the wiper blade 20, in which a wiping element 21 is mounted on the frame 27. To this end, the wiping element 21 comprises lateral grooves allowing cooperation with the blades 28 of the mount 27. The wiping element 21 can thus be slid along the blades 28 of the frame. The wiping element 21 also comprises an extension, opposite the mount 27, forming a wiper blade for contact with the surface to be wiped, in a known manner. As a note, an end piece, not shown, may optionally be added to lock the wiping element 21 after it has been mounted on the mount 27.

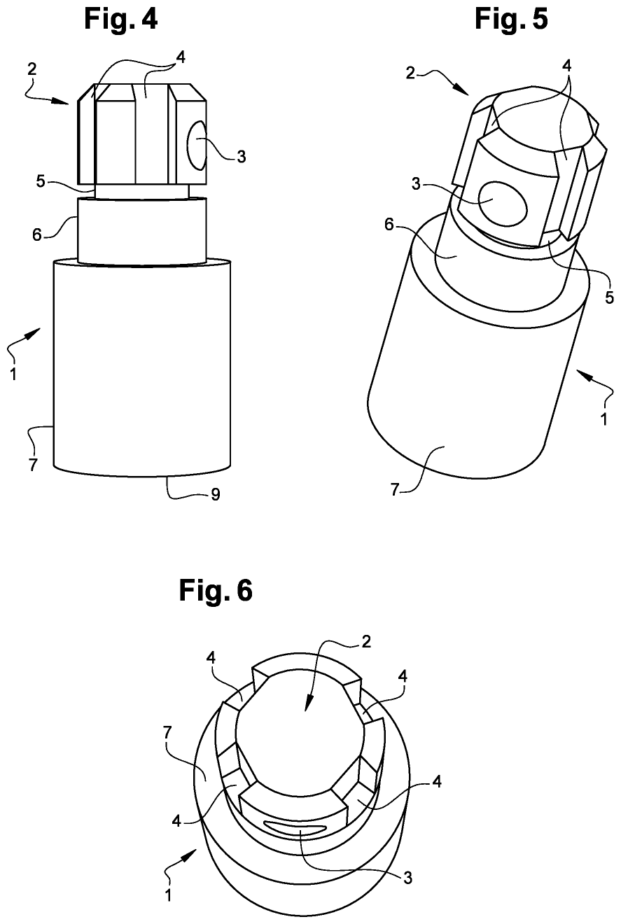

FIGS. 4 to 6 show more particularly the shaft 1 of the wiping system. It comprises a first end forming a connection device 2 intended to cooperate with the wiper blade 20. This first end comprises a first portion having grooves 4, extending parallel to the axis of the shaft 1, on its periphery. This end also comprises a cylindrical through-opening 3, perpendicular to the axis of the shaft 1, intended to receive a pin 13, for example visible in FIG. 9.

The shaft 1 then comprises a second portion 5 of circular cross-section of reduced diameter, corresponding substantially to the diameter measured from one groove 4 to another of the first portion. It then comprises a third portion 6 of larger diameter than the second portion, corresponding substantially to the diameter of the first portion outside the grooves 4. Lastly, it comprises a fourth portion 7 of even larger diameter, which extends to a second end 9 intended for connection to a drive motor, not shown.

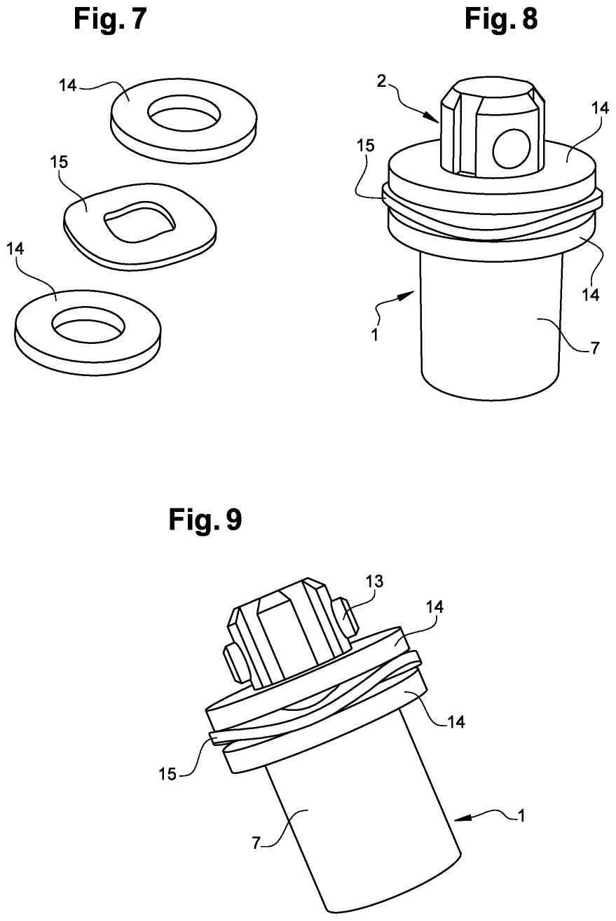

The wiping system further comprises a resilient means, shown in FIG. 7, for mounting on the shaft 1, to cooperate with the wiper blade, as will be explained later. According to this embodiment, the resilient means comprises two flat washers 14 arranged on either side of a resilient washer 15, for example of the onduflex® type.

FIGS. 8 and 9 show the shaft 1 on which the resilient means is mounted. It can be seen that a first flat washer 14 rests on the end of the fourth portion 7 of larger diameter of the shaft, the other two washers 14, 15 resting on this first flat washer 14. FIG. 9 further shows a pin 13 inserted in the above-mentioned cylindrical opening 3 of the shaft 1.

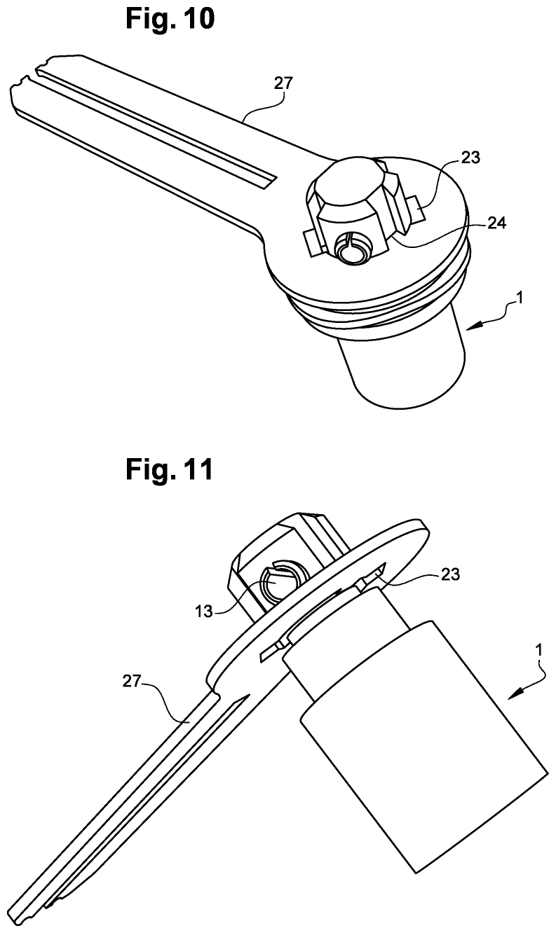

FIG. 1 shows the wiping system fully assembled. FIGS. 10 and 11 show this wiping system assembled but with certain elements removed to better visualise certain details, in particular the relative positioning of the various elements at their connection points. In particular, FIG. 11 shows the positioning of the mount 27 on the shaft 1 in a view from beneath.

The operation of the wiping system will now be detailed, in particular the mounting and dismounting of the wiper blade 20 on the shaft 1.

The assembly of the wiping system comprises firstly the mounting of the resilient means on the shaft 1, and then the pin 13 which secures everything. At this stage, the wiping system is in the state shown in FIG. 9. The mount 27 of the wiper blade is now mounted on the shaft 1. Its connection device 22 is brought close to the corresponding connection device 2 of the shaft 1. For this purpose, the mount 27 is oriented so that its widened portions 23 come to be positioned opposite the pin 13. Their dimensions are designed to allow the pin 13 to pass through the opening formed in the connection device 22 of the mount, which represents the female connector of the coupling. Furthermore, in this orientation, the protrusions 24 come to be arranged opposite the grooves 4: these shapes are designed to allow the protrusions 24 to penetrate the grooves 4. Thus, in this orientation of the elements, the mount 27 can be moved in translation along the shaft 1. This movement in translation is continued until the mount 27 comes into contact with a flat washer 14 of the resilient means. The movement is then continued by compressing the resilient means, more precisely the resilient washer 15, until the connection device 22 of the mount 27 reaches the second portion 5 of the shaft 1: in this position, the mount 27 is then rotated by a quarter turn and then released. It automatically moves upwards until it comes to rest in abutment against the pin 13, under the effect of the resilient means. In the final position or operating configuration, particularly visible in FIGS. 10 and 11, the mount 27 is therefore at the level of the first portion of the shaft 1, and no longer at the level of the second portion 5 of smaller diameter. As a result of this quarter turn, the enlarged portions 23 of the opening of the connection device 22 are no longer aligned with the pin 13, but instead are arranged at right angles. An area of the opening of the connection device 22 of smaller diameter is then located in line with the pin 13, no longer allowing the removal of the mount 27. On the other hand, the connection device 2 of the shaft 1 comprises four grooves 4, evenly distributed around the circumference of the shaft 1. Thus, when the mount 27 is rotated by a quarter turn, the protrusions 24 of the connection device 22 of the mount 27 move from one groove 4 to an adjacent groove. Thus, when the mount moves upward, these protrusions 24 resume a position within a groove 4. This geometry fulfils the anti-rotation function of the mount 27 relative to the shaft 1 and ensures that the mount 27 can be reliably driven by the shaft 1. Lastly, the mount 27 remains under the elastic pressure of the resilient means at all times, abutting against the pin 13, thus forming a locking means. This arrangement ensures the correct positioning of the wiper blade, the wiping element 21 of which thus remains in effective contact against the surface to be wiped.

Disassembly of the wiper blade is carried out by the reverse operation. The wiper blade is first pressed, against the resilient means, to reach the second portion 5 of the shaft 1, which allows its rotation by a quarter of a turn, allowing the widened portions 23 to be repositioned in alignment with the pin 13, thus allowing the movement in translation of the wiper blade and its removal from the shaft 1.

Naturally, the invention is not limited to the embodiment shown. In particular, the complementary shape of the connection devices 2, 22 of the shaft 1 and of the wiper blade 20 respectively could be different from that shown, since they allow a first assembly/disassembly position and a second operating position. On the other hand, the transition from the first position to the second position could be made by a rotation other than a quarter turn. Lastly, the geometry of the elements could be different, as long as it enables the anti-rotation function of the wiper blade to be fulfilled relative to the shaft in the second operating position. Thus, any groove, notch, etc., could be used.

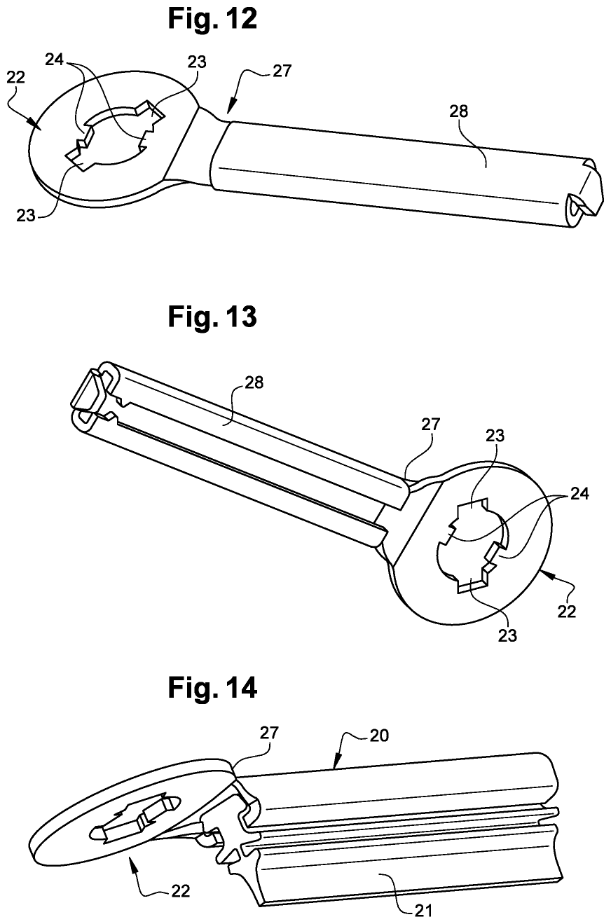

FIGS. 12 to 14 illustrate a variant of the first embodiment, in which the wiper blade 20 differs, the shaft 1 remaining identical. As can be seen in FIGS. 12 and 13, the mount 27 of the wiper blade 20 has a connection device 22 identical to that of the previously described embodiment, but comprises a different blade 28, for receiving a wiper element 21. The single blade 28 has a trough-like profile, open on the side facing the surface to be wiped. This shape allows the blade 28 to have two lower holding claws. This profile allows the insertion and movement in translation of a wiper element 21, the base of which has a corresponding capital I-shaped section (with two perpendicular bars at both ends of the I). It should be noted that such a wiper blade has a smaller width than the wiper blade described above, which reduces the disturbance to the operation of the element to be wiped, for example a camera in a motor vehicle.

FIGS. 15 to 22 illustrate a second embodiment of the invention, which differs principally from the first embodiment in that it comprises an anti-rotation collar 16, positioned between the wiper blade 20 and the pin 13, thus fulfilling the anti-rotation function. This solution makes it possible to simplify the geometry of the shaft 1, as will be described below.

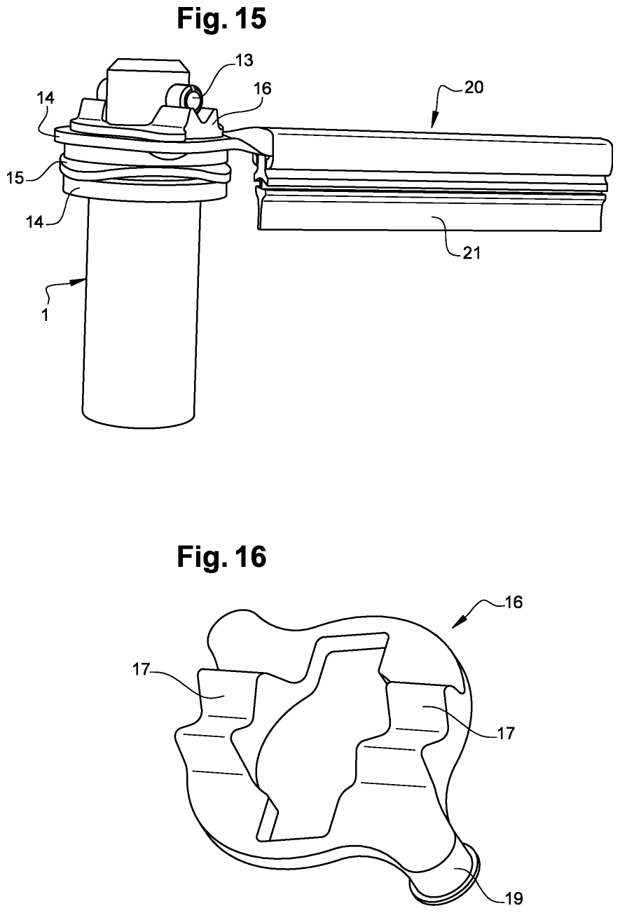

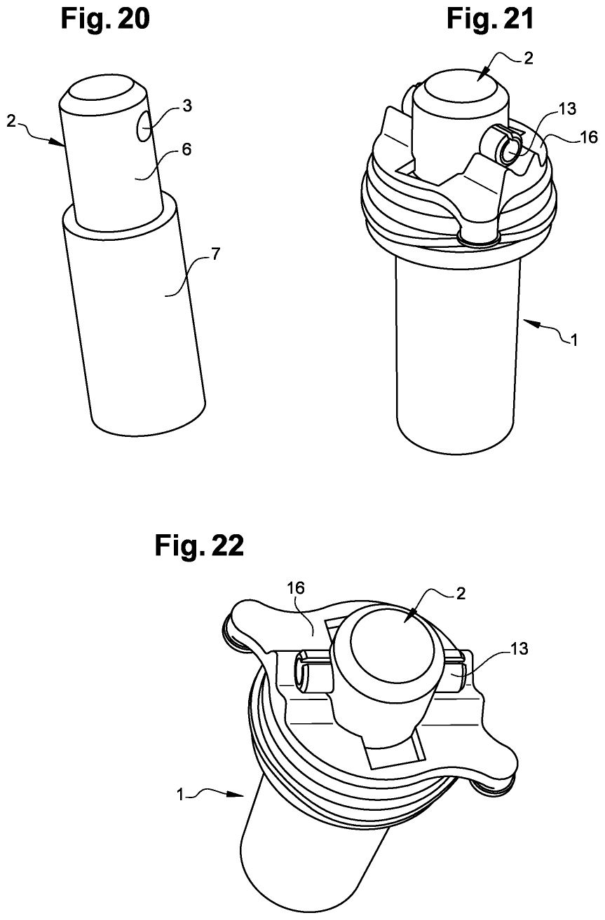

In this second embodiment, the wiper blade 20 firstly comprises a mount 27 and a wiping element 21 identical to those in the variant of the first embodiment. The anti-rotation collar 16, more particularly visible in FIG. 16, is intended for mounting on the wiper blade 20, as shown in FIGS. 18 and 19. It comprises two aligned recesses 17, of V-shaped section, shaped to cooperate with the two ends of the pin 13, as seen in FIGS. 15, 21 and 22. It further comprises two extensions 19 forming connection elements for its mounting on a wiper blade 20.

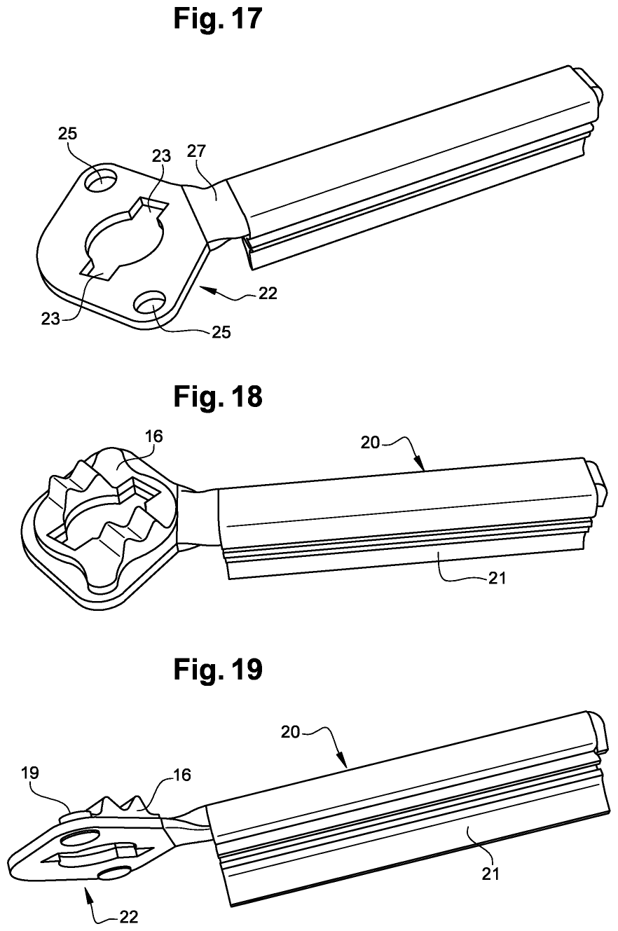

As shown in FIGS. 17 to 19, the anti-rotation collar 16 is fixed to the connection device 22 of the mount 27 of the wiper blade. For this purpose, the connection device 22 comprises two lateral openings 25 which come to be arranged opposite the extensions 19 of the anti-rotation collar 16, thus allowing the latter to be fixed either by clipping or by screwing, or by any other mechanical solution or by gluing. The anti-rotation collar 16 comprises a central opening identical in shape to that of the opening of the connection device 22 of the mount, or with a larger surface area, which is superimposed on this opening of the connection device 22.

Thanks to the use of this additional element, the anti-rotation collar 16, the shaft 1 of the wiping system, particularly visible in FIG. 20, has a simplified shape compared to that of the shaft 1 of the first embodiment. In particular, the first three portions of this shaft 1 are replaced by a single cylindrical portion 6, comprising the cylindrical opening 3 for receiving a pin 13. The same resilient means, in particular the three washers 14, 15, 14 mentioned above, can be positioned around the shaft 1 as in the first embodiment.

The connection device 22 of the wiper blade 20 is likewise simplified. It no longer comprises the protrusions 24 since the shaft 1 no longer comprises grooves 4. It comprises a substantially circular central part, with a diameter slightly greater than that of the cylindrical portion 6 of the shaft 1, and two enlarged portions 23, with a shape corresponding to that of the pin 13. The wiper blade is thus mounted on the shaft and then turned through a quarter turn so as to position the housings 17 of the anti-rotation collar 16 under the ends of the pin 13. When the wiper blade 20 is released, these recesses 17 cooperate with the pin 13, this arrangement being held firmly in place under the effect of the resilient means 15. In this way, the wiper blade cannot escape from the shaft 1 or rotate around the shaft 1. FIGS. 21 and 22 illustrate more precisely the relative positioning of the anti-rotation collar 16 and the shaft 1, particularly the pin 13. It is thus apparent that the anti-rotation collar participates not only in the aforementioned anti-rotation function, but also in the locking function of the wiper blade 20 in the operating configuration.

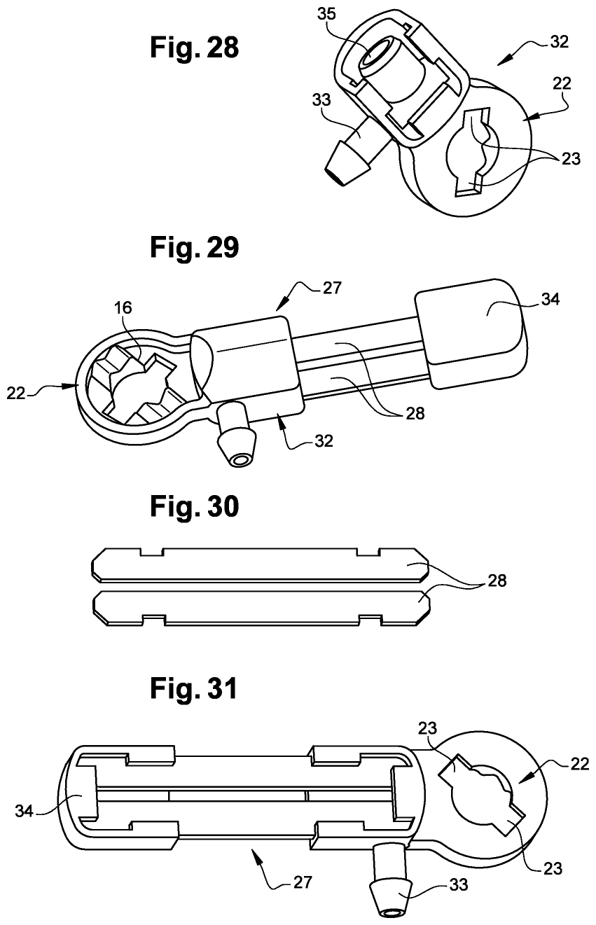

In a variant, not shown, of the second embodiment, the anti-rotation collar 16 might not be a separate element, but might be formed in one piece with all or part of the wiper blade, as will be the case in the embodiment shown in FIG. 28.

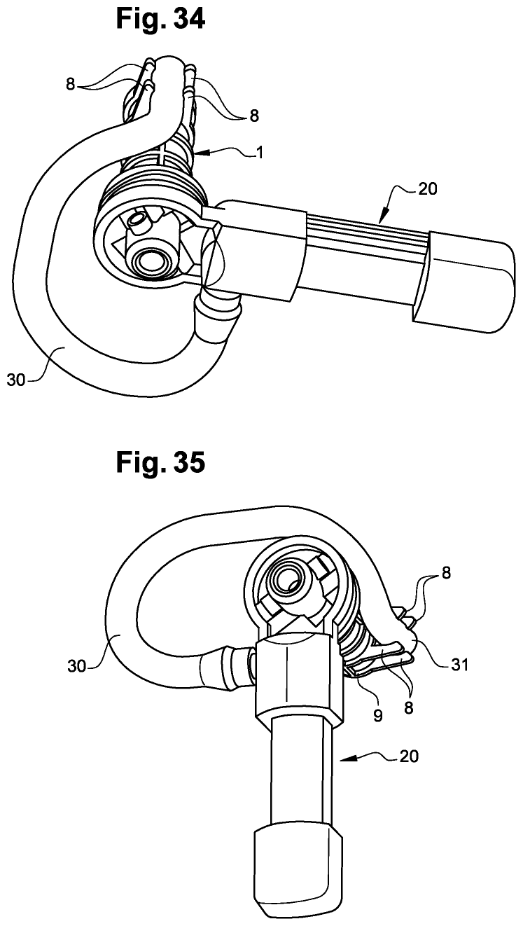

FIGS. 23 to 35 illustrate a third embodiment of the invention.

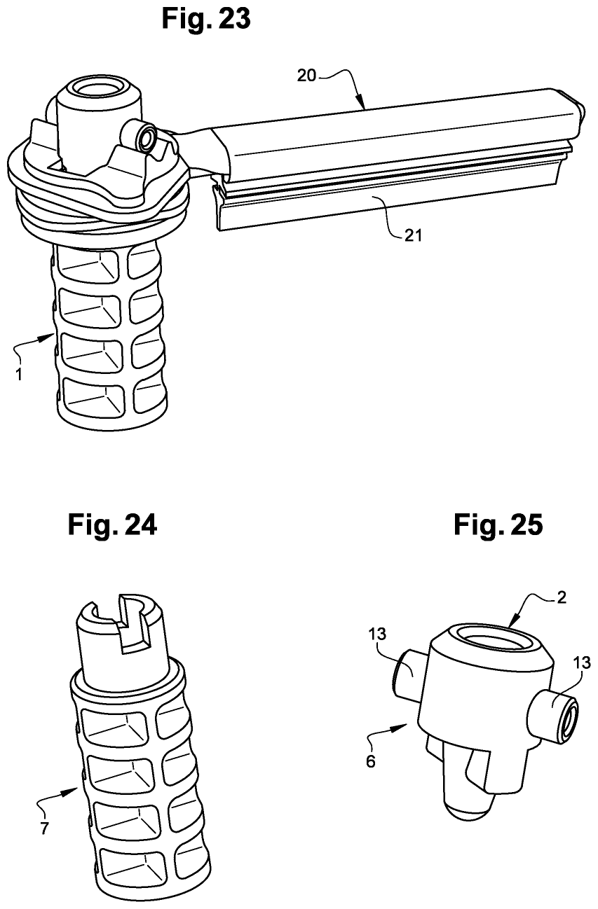

As illustrated in FIGS. 24 to 26, this third embodiment differs from the two previous ones in that the shaft 1 is in the form of two separate main components attached to each other. The lower shaft portion 7 is simplified, of perforated design, as shown in FIG. 24. The upper shaft portion 6, shown in FIG. 25, comprises a connector for cooperating with the lower shaft portion 7, for attachment by, for example, welding, to form a resulting shaft 1, shown in FIG. 26, of similar overall shape to the shaft of the second embodiment. In this embodiment, the pin 13 is no longer an independent element but can be formed in one piece with the upper shaft portion. In fact, it is thus possible to mount the resilient means, in particular the three washers 14, 15, 14 mentioned above, on the lower shaft portion 7, before the upper shaft portion 6 is fixed, thus grouping the resilient means and completing the shaft 1.

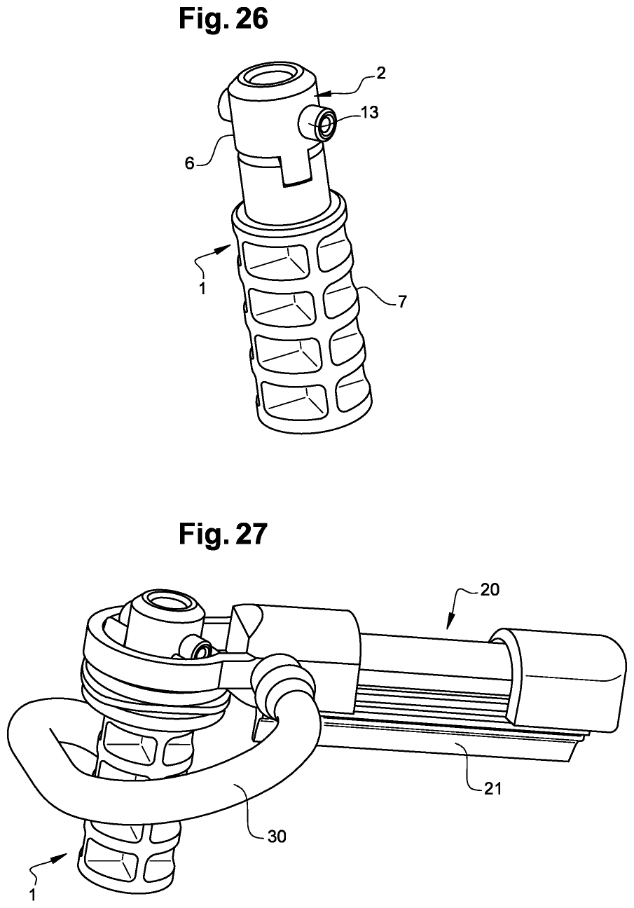

FIGS. 27 to 35 illustrate a variant of the third embodiment, in which the wiper blade incorporates a device for dispensing a cleaning liquid. To this end, the wiping system comprises a hose 30 for supplying the wiper blade 20 with cleaning liquid.

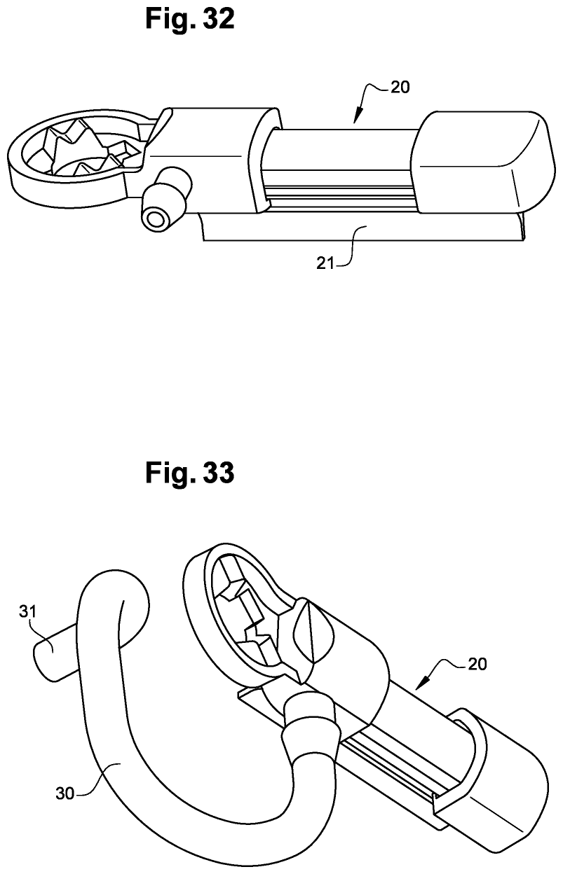

FIGS. 28 to 31 thus illustrate the mount 27 of the wiper blade 20. It comprises a first end piece 32 comprising the connection device 22 for the shaft 1, then a cleaning liquid inlet portion, comprising an inlet connector 33, then an outlet 35 allowing the orientation of the cleaning liquid towards the wiping element 21, then the surface to be wiped. Two parallel blades 28 can be fixed in this first end piece 32. A second end piece 34 is positioned at the opposite end of said two blades 28 to form the mount 27 visible in FIGS. 29 and 31. A wiping element 21 is then fixed to this mount 27, to form the wiper blade 20 shown in FIG. 32. A hose 30 bent to match the shape of the shaft 1, shown in FIG. 33, has one end attached to the inlet connector 33 and a second end 31 for connection to a cleaning liquid supply device, not shown.

The shaft 1 comprises lugs 8 at its second end 9 for clipping the pipe 30 at its second end 31, where it assumes a straight shape parallel to the shaft 1, to minimise the overall footprint increased by the pipe 30

Lastly, the invention is not limited to the described embodiments. In particular, these may be combined with each other.

In all embodiments, the mount 27 may be made of metal or even rigid plastic. The wiping element 21 is preferably made of rubber, as is known. The collar may be made from plastic or metal. The shaft 1 is preferably made from metal

In addition, various elements of the wiping system may take other forms without departing from the concept of the invention. For example, any other resilient means could be used, comprising for example at least one spring, in particular a helical or leaf spring. Alternatively, the resilient means could be mounted on the wiper blade 20, at the connection device 22 of the latter, and not on the shaft. The drive shaft 1 and the wiper blade 20 may take different forms. For example, the pin on the shaft 1 could take any other form to provide a stop for the wiper blade 20 in the operating configuration. In the embodiments, the pin forms two symmetrically opposed stops about the axis of the shaft to ensure stability in the operating configuration. Alternatively, the shaft could comprise more than two stops, for example three or four stops, distributed around its axis. Advantageously, the shaft is symmetrical about its axis, which also represents its axis of rotation. The anti-rotation device can also take any form other than those shown: it comprises complementary anti-rotation means arranged on the drive shaft 1 and on the wiper blade 20. The anti-rotation device may be independent of the wiper blade locking means or may be combined with it. The first embodiment uses grooves distributed evenly around the shaft. Alternatively, any notch machined into the shaft could be used.

The connection of the drive shaft 1 and of the wiper blade 20 may also be different, provided it allows their releasable assembly involving a simple relative rotation, including an anti-rotation device and a locking device, with the participation of a resilient means. In the described embodiments, the wiper blade thus comprises a female connection device, and the shaft 1 a complementary male connection device. These female/male parts could be reversed. In any case, the wiper blade 20, or more simply an individual part such as a mount 27, or even an individual part 32 of the mount 27, comprises a connection device 22 suitable for a releasable connection to a drive shaft 1 of the wiper blade 20, this connection device 22 comprising a first orientation which allows mounting/dismounting relative to a drive shaft 1, and a second orientation which does not allow this mounting/dismounting.

The invention is particularly suitable for wiping small active surfaces of cameras or lighting devices, especially for motor vehicles. However, it remains compatible with any other application requiring the cleaning of a surface.

What is claimed is:

1. Wiper blade for a wiping system, in particular for wiping a camera of a motor vehicle, characterized in that the wiper blade comprises a connection device suitable for releasable connection to a drive shaft of the wiper blade, said connection device comprising a first orientation which allows mounting/dismounting relative to a drive shaft, and a second orientation which does not allow such mounting/dismounting.

2. Wiper blade for a wiping system according to claim 1, characterized in that the connection device comprises an opening at one end of the wiper blade, comprising at least two enlarged portions for mounting and dismounting of the latter.

3. Wiper blade for a wiping system according to claim 1, characterized in that it comprises an anti-rotation means, in particular by at least one protrusion at an opening of its connection device or by a collar comprising at least one housing for cooperating with at least one stop of a drive shaft.

4. Wiper blade for a wiping system according to claim 1, characterized in that the wiper blade comprises a mount forming guides for the releasable translational attachment of a wiping element intended to come into contact with the surface to be wiped.

5. Wiping system, characterized in that it comprises a drive shaft and a wiper blade according to claim 1, said blade being releasably attached to this drive shaft.

6. Wiping system according to claim 5, characterized in that it comprises an operating configuration in which a resilient means exerts a force on the wiper blade tending to hold it in abutment against at least one stop of the drive shaft, in particular a pin, to lock the wiper blade in this operating configuration.

7. Wiping system according to claim 5, characterized in that the wiper blade and the drive shaft comprise respective connection devices configured to allow their assembly and/or disassembly by their successive actuation according to a first relative movement in translation parallel to the axis of the drive shaft then a second rotational movement relative to the axis of rotation corresponding to the axis of the drive shaft.

8. Wiping system according to claim 6, characterized in that the wiper blade and the drive shaft comprise respective anti-rotation means configured to form an anti-rotation device for the wiper blade relative to the drive shaft in said operating configuration.

9. Wiping system according to claim 8 characterized in that the drive shaft comprises a first portion with grooves forming an anti-rotation means, and in that the wiper blade comprises an opening with protrusions of a size corresponding to the grooves, configured to fit into the grooves in said operating configuration of the wiping system and to form an anti-rotation device.

10. Wiping system according to claim 8, characterized in that the drive shaft comprises a pin forming an anti-rotation means and a locking stop, and in that the wiper blade comprises an anti-rotation collar comprising recesses configured to co-operate with the pin in said operating configuration of the wiping system, thereby forming an anti-rotation means and a means for locking the wiper blade to the drive shaft.

11. Wiping system according to claim 6, characterized in that the resilient means comprises a resilient washer, in particular arranged between two flat washers (14).

12. Camera or lighting device for a motor vehicle, characterized in that it comprises at least one wiping system according to claim 5.

13. Motor vehicle, preferably an autonomous motor vehicle, characterized in that it comprises at least one wiping system according to one of claim 5 or a camera or lighting device.
